(19) United States
(12) Patent Application Publication
(10) Pub. No.: US 2026/0247120 A1
(43) Pub. Date: Aug. 20, 2026

(54) SYSTEMS AND METHODS FOR NETWORK SLICE METERING

(71) Applicant: T-MOBILE INNOVATIONS LLC, Overland Park, KS (US)

(72) Inventor: Murugappan PALANIAPPAN, Issaquah, WA (US)

(21) Appl. No.: 19/058,519

(22) Filed: Feb. 20, 2025

(51) Int. Cl. H04W 4/50; H04L 12/14

(52) U.S. Cl. CPC H04W 4/50; H04L 12/1435; H04L 12/1439

(57) ABSTRACT

Methods and systems are provided for network slice metering, during which an application programming interface (API) session is initiated at a wireless device, an availability of a session for the API on a network slice is validated at an identity access management (IAM) node, a service offer code (SOC) associated with the network slice is added at a network as a service (NaaS) node; and the wireless device is attached to a core network associated with the network slice at a network provisioning engine (NPE).

### TECHNICAL BACKGROUND

Wireless devices, or user equipment, often are capable of connecting to different types of access nodes, such as an evolved NodeB (eNodeB), for LTE/4G, and a next generation Node B (gNodeB) for 5G. For connections to a 5G network, a network slicing feature is available. Network slicing allows a single network to be divided into multiple slices. Each slice can be configured and used in its own way. For example, a network slice may be established and configured for a Mobile Virtual Network Operator (MVNO) to lease from a larger cellular service provider to a small cellular service provider. As another example, network slices may be configured for different Quality of Service (QoS) levels such as a network slice for video streaming with its high bandwidth requirements and another for voice over IP (VOIP) with its low latency but lower bandwidth requirements. However, network slicing is not available for older networks such as LTE networks.

### OVERVIEW

Exemplary embodiments described herein include systems and methods for network slice metering. An example system includes a wireless device connected to a network slice. The system further includes a wireless network comprising at least one computing device communicatively connected to the wireless device. The at least one computing device is configured to perform operations by executing instructions to transmit a first data policy to apply to data at the wireless device from a session management function (SMF) node to a policy control function (PCF) node, metering an amount of data used by the wireless device at a subscription system node, determining that the amount of data used by the wireless device is a threshold amount of data at the subscription system node, and transmitting a second data policy to apply to data at the wireless device from the SMF node from the PCF node.

An example method includes establishing an application programming interface (API) session at a wireless device. The method then includes validating an availability of a session for the API on a network slice, where the validation occurs at an identity access management (IAM) node. A service offer code (SOC) associated with the network slice may be added at a network as a service (NaaS) node. The method then includes attaching the wireless device to a core network associated with the network slice, wherein the attachment occurs at a network provisioning engine (NPE).

Another example method includes establishing an application programming interface (API) session on a wireless device at a session management function (SMF) node. The method further includes transmitting, from a policy control function (PCF) node to the SMF node, a data policy corresponding to the API session on the wireless device. The method then includes uplifting the API session to a network slice in response to the transmitted data policy. The method further includes metering, at a subscription system node, an amount of data used by the wireless device on the network slice.

### BRIEF DESCRIPTION OF THE DRAWINGS

FIG. 1 illustrates an exemplary system for wireless device communication in accordance with disclosed embodiments.

FIG. 2 illustrates an additional exemplary system for network slice metering in accordance with disclosed embodiments.

FIG. 3 illustrates an example method for network slice metering in accordance with disclosed embodiments.

FIG. 4 illustrates another example system for network slice metering in accordance with disclosed embodiments.

FIG. 5 illustrates another example method for network slice metering in accordance with disclosed embodiments.

### DETAILED DESCRIPTION

5G core networks have the ability to provide network slices to allow for many virtualized networks to be provided on the hardware architecture of the cellular network operator. One use of network slicing is to provide different levels of Quality of Service (QoS) depending on the needs of the wireless devices using the network slices and the needs of the network operator providing them. Network slices can be created and configured for many different levels of QoS. For example, a network slice for video streaming requires high bandwidth and low latency. As another example, a network slice for voice calls would require lower bandwidth and tolerate higher latency than video calls. Each network slice may be created with specific parameters. Some of these parameters control the QoS for the network slice. These parameters control things such as data rates, latency, reliability, and traffic prioritization.

During use of a wireless device, a user can request access to a network slice having a particular QoS. This request is known as Quality on Demand (QoD). A QoD request may be made by an application to allow the application to have improved connection parameters, such as bandwidth and latency. QoD sessions may be governed by a standards governing body, which may set norms for QoD sessions, such as the Camara specification. One such norm may relate to how a QoD session is monitored and metered. More particularly, a QoD session, once established, may be set to run for a standard period of time. A timer may monitor the time spent on the network slice and, once the user has reached the standard period of time, the QoD request may be renewed (keeping the user on the upgraded network slice) or the user may be removed from slice.

Use of an uplifted network slice as part of a QoD request further implicates data usage for the user of the wireless device, as the increased connection quality may require more data to be used. However, depending on factors such as the particular subscription plan of the wireless device, a user may desire to limit the amount of data used on the uplifted network slice. For example, a user who has a particular amount of data included within their subscription plan and pays for data use above that particular amount of data may wish to restrict the amount of data used in any one QoD session. By contrast, a user whose subscription plan includes unlimited data usage may desire to remain on the uplifted network slice for the entirety of the QoD session. Thus, while monitoring based on a period of time, as is traditional for a QoD session, may not present a data concern for a user with unlimited data, a user who desires to limit the amount of data used in any one QoD session may use the amount of data prior to the full time period of the QoD session elapsing.

Thus, exemplary embodiments described herein include systems and methods for network slice metering, and particularly for metering on an uplifted network slice. For example, when a QoD request is made by a wireless device, a data policy associated with the wireless device may be transmitted to a session management function (SMF) node of the wireless network. Once the wireless device is attached to a network slice associated with the QoD request and subsequent QoD session, a subscription service node may monitor data usage of the wireless device on the network slice. More particularly, the subscription service node may monitor data usage in accordance with the data policy associated with the wireless device. Simultaneously, a Network as a Service (NaaS) node may monitor an amount of time that the wireless device is on the network slice. Thus, in situations where the amount of data to be used while on the network slice is capped, the subscription service node is able to monitor the data usage and, upon the QoD session reaching the capped data amount, may act to move the wireless device off the network slice associated with the QoD session. This may occur even if the time period of the QoD session has not been reached (i.e., if the wireless device has not been on the network slice for the standardized amount of time for a QoD session). By contrast, in situations where the amount of data to be used on the network slice is unlimited, the subscription service node will not act to move the wireless device off the network slice unless the standardized amount of time is reached. Thus, a wireless network is able to customize its QoD offerings and network slices based on different subscription plans of users, without creating separate network slices for each permutation of the subscription plans offered by the wireless network.

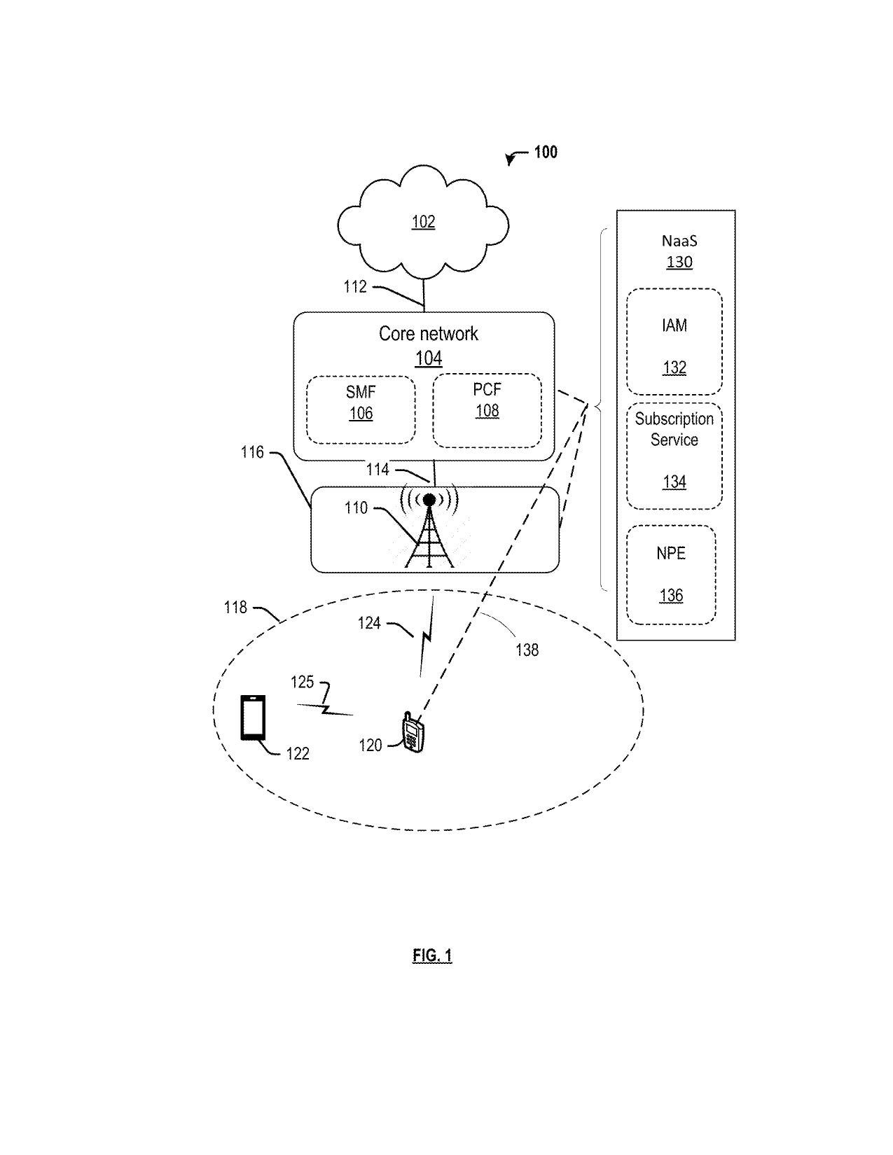

These and other examples will be described in greater detail below in relation to FIGS. 1-5.

FIG. 1 depicts an exemplary system 100 for network node switching. System 100 includes a communication network 102, a core network 104, a Network as a Service (NAAS) node 130, and at least one wireless device, which may be a device 120 or virtual wireless device 122.

Core network 104 is connected to communication network 102 over communication link 112. Core network 104 includes a session management function (SMF) node 106 and a policy control function (PCF) node 108. SMF node 106 is The SMF is primarily responsible for creating, updating, and removing sessions and managing session context within the 5G service based architecture (SBA). PCF node 108 is responsible for policy enforcement and quality of service (QoS) management. In some embodiments, PCF node 108 is configured to be updated by mapping a data network name (DNN) associated with a network slice serving a device, such as wireless device 120 or wireless device 122, to an access point name (APN) for the network slice serving the wireless device. For example, when a QoD request is made by a wireless device, such as wireless device 120 or 122, the PCF 108 may transmit an associated data policy to the SMF node 106, allowing the SMF node 106 to uplift the QoD session to a network slice associated with a service offer code (SOC). In some embodiments, PCF node 108 may be updated as to update a subscription expiration for the network slice. For example, a slice may be only valid during a validity period, such as set start and end date, or may expire after a usage limit, such as a data cap for the slice. If the slice is no longer valid, PCF node 108 may update the SMF node 106 to remove the parameters associated with that slice. It should be noted that core network 102 may include other components used for managing data for networks not described herein, such as a satellite core network.

A radio access network (RAN) 116 may include an access network system and device such as access node 110. The RAN 116 is disposed between the core network 104 and the end-user wireless devices 120, 122. Components of the RAN 116 may communicate directly with the core network 104 and others may communicate directly with the end user wireless devices 120, 122. The RAN 116 may provide services from the core network 104 to the end-user wireless devices 120, 122.

The RAN 116 includes an access node (or base station) 110, which may include one or more access nodes communicating with the end-user wireless devices 120, 122. It should be understood that the disclosed technology may also be applied to communication between an end-user wireless device and other network resources, such as relay nodes, controller nodes, antennas, etc. The RAN 116 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 110 can be, for example, standard access nodes such as a macro-cell access node, a base transceiver station, a radio base station, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access node 110 may comprise a short range, low power, small-cell access node such as a microcell access node, a picocell access node, a femtocell access node. Access node 110 can be configured to deploy one or more different carriers, utilizing one or more RATs. Any other combination of access nodes and carriers deployed therefrom may be evident to those having ordinary skill in the art in light of this disclosure.

The access node 110 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The system 100 also includes a network as a service (NaaS) node 130. NaaS node 130 allows access to and management of network connectivity for a device, with the Naas node 130 serving as a runtime engine. NaaS node 130 includes an identity and access management (IAM) node 132 IAM node 132 may be configured to receive a QoD request from a wireless device, such as wireless device 120, and determine that the wireless device is permitted to engage with a network slice associated with a higher QoS.

NaaS node 130 may further include subscription service node 134. Subscription service node 134 may track a data bucket limit for any QoD session initiated as a result of a QoD request. In some examples, subscription service node 134 may communicate with the SMF node 106 and/or the PCF node 108 to ensure that policies associated with a particular wireless device are enforced. Moreover, subscription service node 134 may be in communication with a wireless device such as wireless device 120 or 122. In particular, subscription service node 134 may communicate with a user on a QoD session to inform the user that the current QoD session is approaching a termination point, whether due to data usage or due to time, and may seek input from the user as to what action should be taken. Example options for actions taken presented by the subscription service node 134 may include extending the session (with a potential additional cost), termination of the session, and continuing the current session with throttled speed.

A network provisioning engine (NPE) node 136 may further be included within the NaaS node 130. An NPE node 136 refers to a provisioning layer within the NaaS node 130 which is designed to configure and manage network elements and manage allocation of network resources. Thus, NPE node 136 may be configured to set a limit at the subscription service node 134 in response to the PCF node 108 transmitting an associated policy for data usage related to a QoD session, allowing the subscription service node 13 to start the meter associated with the network slice for the QoD session. In some examples, the NPE node 136 may aid in attaching a wireless device such as wireless devices 120 and 122 to the upgraded network slice by canceling device location, thus forcing the device to reattach to core network 104 to attach to the uplifted network slice.

NaaS node 130 may be in communication with both the wireless devices 120 and 122, with the core network 104, with the NPE node 136, and/or with an access node 110. It should be noted that NaaS node 130 may include other components used for management of network connectivity not described herein, such as a KONA layer.

System 100 also includes a wireless device 120 and a wireless device 122. In embodiments, system 100 may include multiple wireless devices. Wireless devices 120 and 122 are configured to operate in one or more coverage areas 118. Wireless device 120 may be an end-user wireless device and may be a smart phone or other cellular telephone. Wireless device 122 may be a virtual end-user wireless device, such as a virtual reality (VR) or augmented reality (AR) device. However, examples are not so limited and the wireless devices 120, 122 may include any wireless device included in a wireless network. For example, the term “wireless device” may include a relay node, which may communicate with an access node. The term “wireless device” may also include an end-user wireless device, which may communicate with access nodes 110 through a relay node. The term “wireless device” may further include an end-user wireless device that communicates with the access node 110 directly without being relayed by a relay node.

Wireless devices 120, 122 may be any device, system, combination of devices, or other such communication platform capable of communicating wirelessly with access nodes 110 using one or more frequency bands and wireless carriers deployed therefrom. Each of wireless devices 120, 122, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless devices 120, 122 may be or include high power wireless devices or standard power wireless devices. Other types of communication platforms are possible.

In embodiments, wireless device 120 communicates with RAN 116 over communication link 124. Examples of communication link 124 may include 5G network. In addition, wireless device 122 may communicate with wireless device 120 via communication link 125.

Communication network 102 may be wired and/or wireless communication network. In embodiments, communication network 102 may include processing nodes, routers, gateways, physical and/or wireless data links for carrying data among various network elements, including combinations thereof. In embodiments, communication network 102 may include a local area network, a wide area network, an inter-network, such as the internet, and the like. Communication network 102 may be capable of carrying data, such as, for example, to support multimedia files, and data communications by wireless devices 120, 122. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 102 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 102, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), such as PCF node 108, a unified data management (UDM) function, an application function (AF), an AMF, an authentication server function (AUSF), and a session management function (SMF) node, such as SMF node 106. Additional or fewer control plane functions may also be included. The AMF receives connection and session related information from the wireless devices 120 and is responsible for handling connection and mobility management tasks. The UDM function provides services to other core functions, such as the AMF, SMF node 106, and NEF. The UDM may function as a stateful message store, holding information in local memory. The NSSF can be used by an AMF to assist with the selection of network slice instances that will serve a particular device. Further, the NEF provides a mechanism for securely exposing services and features of the core network.

Although one core network 102 is shown, multiple core networks 102 may be utilized. Alternatively, the single core network 102 may include a distributed, cloud-native, converged core gateway.

Communication links 112 and 114 can use various communication media, such as air, space, metal, optical fiber, or some other signal propagation path, including combinations thereof. Communication links 112 and 114 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 112 and 114 can be direct links or might include various equipment, intermediate components, systems, and networks, such as a cell site router, etc. Communication links 112 and 114 may comprise many different signals sharing the same link.

The wireless device 120 may include any wireless device included in a wireless network. For example, the term “wireless device” may include a relay node, which may communicate with an access node. The term “wireless device” may also include an end-user wireless device, which may communicate with access nodes 171 through the relay node. The term “wireless device” may further include an end-user wireless device that communicates with the access node 171 directly without being relayed by a relay node.

Wireless device 120 may be any device, system, combination of devices, or other such communication platform capable of communicating wirelessly with access nodes 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless device 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless device 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for network node switching may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

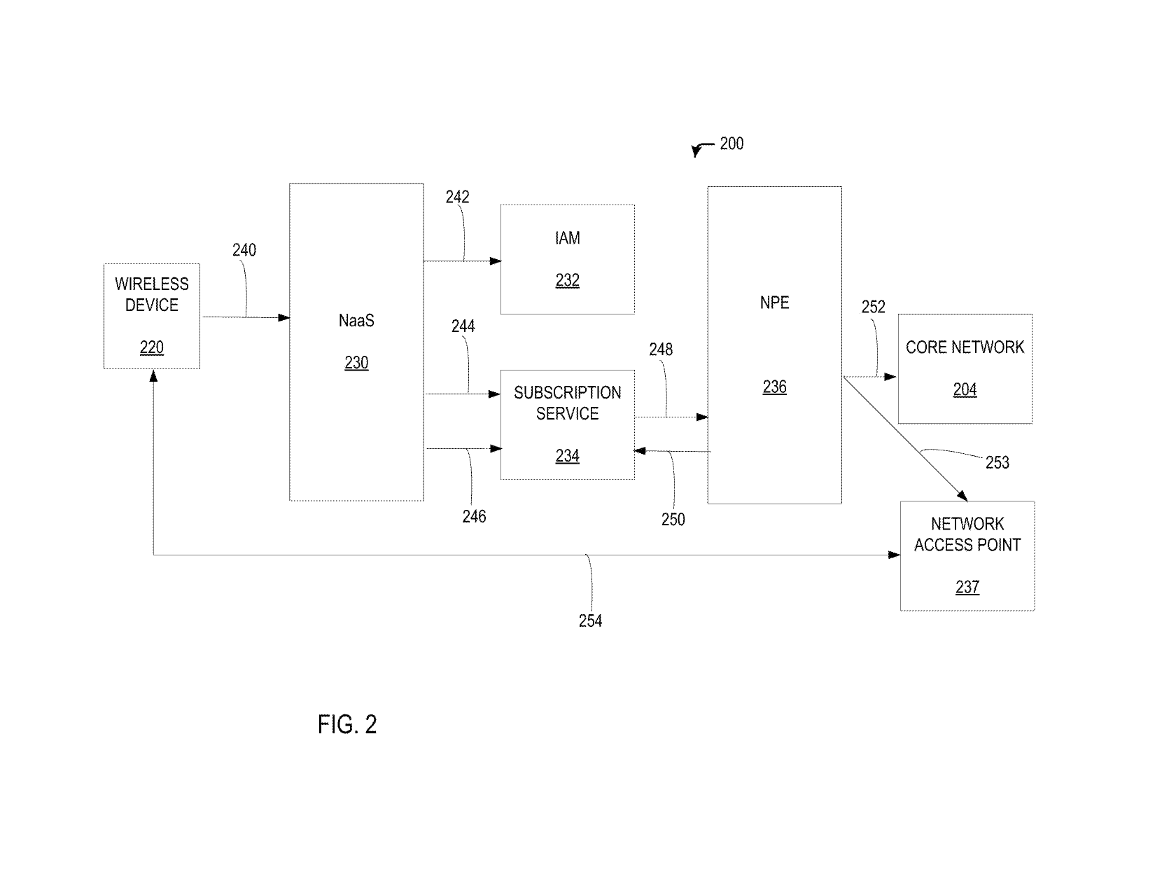

Now referring to FIG. 2, an exemplary system 200 for network slice metering is presented. System 200 includes a wireless device 220. Wireless device 220 may be the same as wireless device 120 and, although not shown in FIG. 2, it should be understood that system 200 may further include a wireless device 222, which may be the same as wireless device 122. System 200 also includes core network 204, which may be the same as core network 104 and may include a session management function (SMF) node and a policy control function (PCF) node, such as SMF node 106 and PCF node 108. In addition, system 200 may include a network as a service (NaaS) node 230, an identity access management (IAM) node 232, a subscription service node 234, and a network provisioning engine (NPE) node 236, which may be the same as Naas node 130, IAM node 132, subscription service node 134, and NPE node 136, respectively.

NaaS node 230 receives a QoD request from wireless device 220, as shown by arrow 240. The QoD request may take the form of an application program interface (API) call, which may include a mobile station international subscriber directory number (MSISDN), an application identifier (APP ID), and a specification that the feature being sought as part of the QoD request is access to a video slice. Upon receiving the QoD request, the NaaS node 230 may forward the MSISDN, the APP ID, and the feature specification to the IAM node 232, as shown by arrow 242. The IAM node 232 may validate the MSISDN, APP ID, and feature, confirming that the wireless device 220 is able to access the requested video slice.

NaaS node 230 may further transmit the QoD request to the subscription service node 234, as shown by arrow 244, allowing the subscription service node 234 to validate that the wireless device 220 has a sufficient amount of time and/or data available to access the requested video slice. In addition, NaaS node 230 may add a service offer code (SOC) associated with the video slice when transmitting the QoD request to the subscription service node 234; this SOC addition is shown by arrow 246.

Once the subscription service node 234 receives the SOC, the subscription service node 234 may transmit the SOC to the NPE node 236, shown at arrow 248. In addition, NPE node 236 may instruct the subscription service node 234 to begin metering for the QoD request, shown by arrow 250. The NPE node 236 is then able to communicate the SOC to the core network 204, shown by arrow 252. Once the core network 204 receives the SOC associated with the video slice, core network 204 is able to uplift the wireless device 220 to the video slice, shown by arrow 254.

System 200 may include additional components used for management of network connectivity not shown in FIG. 2, such as a KONA layer and/or network access point (NAP) layer. These components may be integrated with the system 200 and may aid in communication between and amongst the various nodes of system 200.

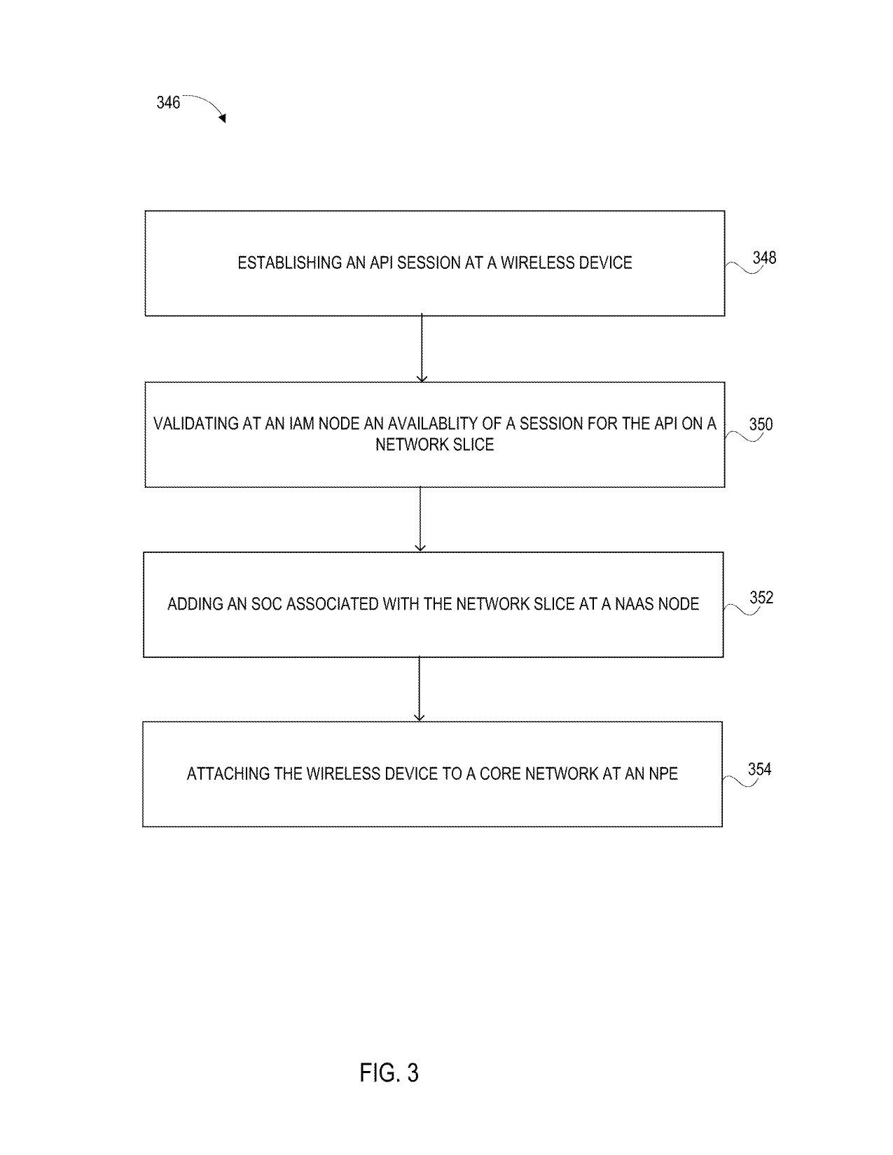

FIG. 3 illustrates an example method 346 for network slice metering. Method 332 may be performed by any suitable combination of processors and nodes discussed herein, for example a processor contained in a network as a service (NaaS) node.

Method 346 begins at step 348 with establishing an application programming interface (API) session at a wireless device. An API session may refer to a session communicating between two computing devices, such as a wireless device and a network. In some examples, the API session may take the form of a Quality on Demand (QoD) request, in which a user is requesting access to a particular network slice. In such examples, the API request may include information including a mobile station international subscriber directory number (MSISDN), an application identifier (APP ID), and a feature request, with the feature request corresponding to the particular slice for which access is being requested (e.g., a video slice).

Method 346 continues at step 350 with validating, at an identity access management (IAM) node, an availability of a session for the API on a network slice. The IAM node may validate the information including the MSISDN, APP ID, and feature request that are part of the API session established at step 348. In such examples, the IAM node may validate the identify of the wireless device in addition to validating that the wireless device is permitted to access the requested network slice. This validation of permission may include, for example, validating that time is available on the network slice and/or that the wireless device has a sufficient amount of available data to engage with the network slice.

At step 352, method 346 include adding a service offer code (SOC) associated with the network slice at a network as a slice (NaaS) node. An SOC refers to a code used by a provider, such as a wireless network, to identify and activate a particular feature. In the present examples, the SOC may be correlated with a particular network slice, such that adding the SOC associates the API session with the network slice. In some examples, adding an SOC at the NaaS node at step 352 may comprise instructing a subscription service to establish the associated network slice. In such examples, the newly established network slice will then be associated with the SOC.

Method 346 continues at step 354 with attaching the wireless device to a core network associated with the network slice. The wireless device may be attached at a network provisioning engine (NPE). In some examples, attaching the wireless device to a core network at an NPE may include transmitting a “cancel location” to the wireless device from the NPE. A cancel location will remove or otherwise cancel any prior network attachment of the wireless device. The NPE may then reattach the wireless device to the core network, allowing the wireless device to be moved to the network slice.

Method 346 may further include activating a meter at the NaaS node. The meter may be activated in response to the wireless device being attached to the core network associated with the network slice at step 354. In some examples, the meter may correspond to data usage, such that activating a meter at the NaaS node may comprise monitoring an amount of data usage by the wireless device on the network slice. More particularly, monitoring an amount of data usage by the wireless device may occur at a subscription node contained within the NaaS node. In such examples, the NaaS node may further note that a threshold amount of data to be used exists. The threshold amount of data may correspond to an amount of data set by a user of the wireless device or may be determined by the validation at the IAM node at step 350. In other examples, the meter may correspond to time, such that activating a meter at the NaaS node may comprise monitoring an amount of time that the wireless device is on the network slice. In some examples, both a data meter and a time meter may be activated at the NaaS node.

Method 346 may further include determining, at a network access point (NAP), that the network slice is established. The determination of the establishment of the network slice may occur as part of the addition of an SOC at the NaaS node. Upon determination of the establishment of the network slice, method 346 may include instructing the NaaS node to begin the API session on the network slice. Beginning the API session may establish the session on the network slice and may serve as the starting point for the metering described previously.

In some examples, after the wireless device has been attached to and active on the network slice, method 346 may further include determining that a meter threshold has been reached. In some examples, the meter threshold may correspond to a threshold amount of data that the wireless device is not permitted to exceed. In other examples, the meter threshold may be a time threshold and may correspond to a standard amount of time allowed on a network slice. In either case, responsive to determining that the meter threshold has been reached, method 346 may include moving the wireless device off the network slice, returning the wireless device to a base slice.

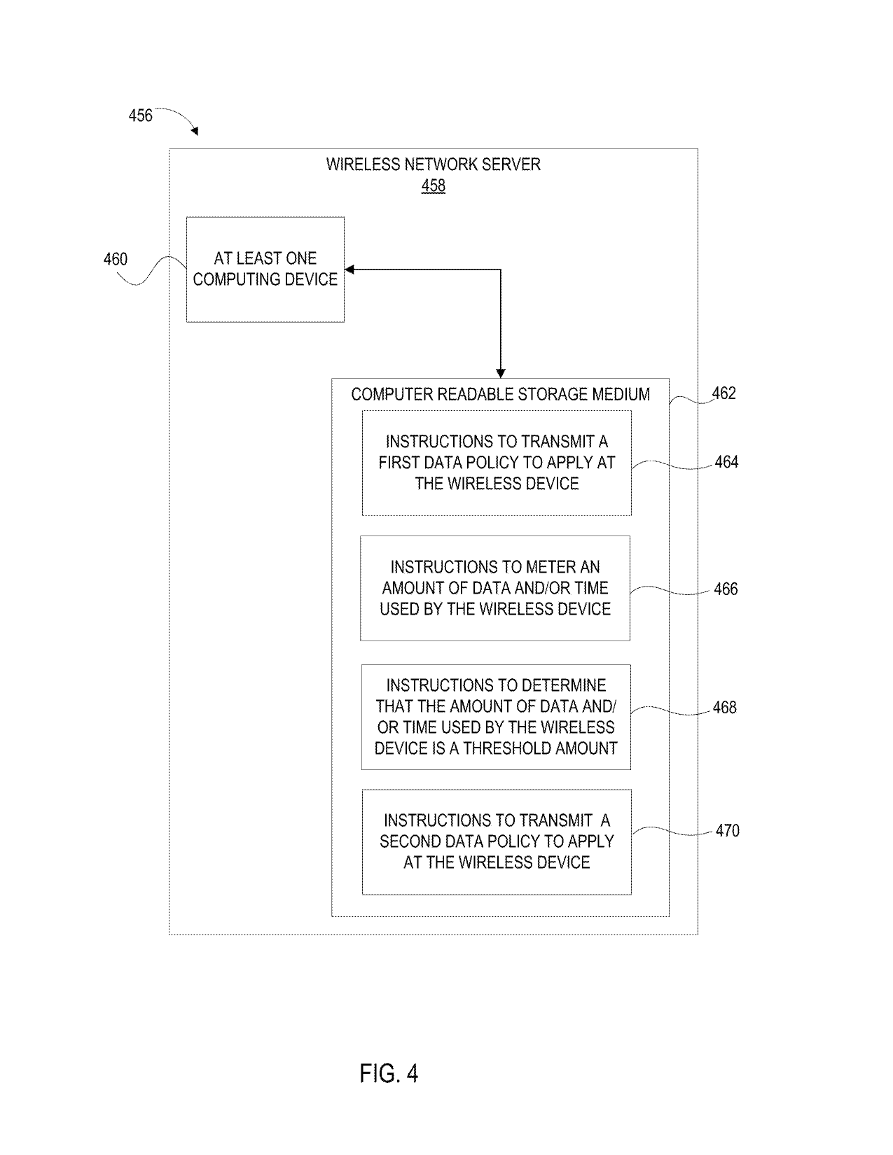

Turning now to FIG. 4, an example system 456 for network slice metering in accordance with disclosed embodiments is illustrated. System 456 includes a wireless network server 458. Wireless network server 458 includes at least one computing device 460 including an electronic processor and computer readable storage medium 462, which can comprise a disk drive, flash drive, memory circuitry, or other memory device including, for example, a buffer. Computer readable storage medium 462 may include computer programs, firmware, or some other form of machine-readable instructions, such as instructions 464, 466, 468, and/or 470, which may instruct the at least one computing device 460 to perform associated operations. Computer readable storage medium 462 includes an operating system, utilities, drivers, network interfaces, applications, or some other type of software. The at least one electronic processor contained as part of the at least one computing device 460 may include circuitry to retrieve and execute instructions stored on computer readable storage medium 462, which may be internal or external to wireless network server 458. System 456 may further include other components such as a power management unit, a control interface unit, etc., which are omitted for clarity. System 456 may be included in various elements of the wireless network including an access node, a session management function (SMF) node, a policy control function (PCF) node, or a network as a service (NaaS) node, for example.

Instructions 464 may be executed by the at least one computing device 460 to transmit a first data policy to apply at a wireless device. The wireless device may be the wireless devices 120 or 122, shown in FIG. 1, or wireless device 220, shown in FIG. 2. In some examples, the first data policy may be transmitted to an SMF node from a PCF node. The SMF node and PCF node may be part of a core network, as shown in FIG. 1 and discussed with respect thereto. In some examples, the first data policy may correspond to an uplift session corresponding to accessing data over the network slice. In such examples, transmitting a first data policy to apply to data may further include transmitting a notification that the wireless device is on a network slice to an enterprise multi-mediation (EMM) node from a subscription system node. As used herein, an EMM node refers to a mediation system that aids in data and application management within a device. The EMM node also creates a call data record (CDR), which refers to a record detailing a telecommunication transaction. In some examples, transmitting the first data policy to apply to data may further comprise transmitting a CDR that includes an indication that the wireless device is on the network slice from the EMM node to a subscription service node. More particularly, an uplift session CDR may be transmitted from the EMM node to the subscription system node, indicating that the wireless device is on the network slice. In some examples, the first data policy may specify an amount of data and/or an amount of time for the wireless device to use in an uplift session.

Instructions 466 may be executed by the at least one computing device 460 to meter, at a subscription system node, an amount of data and/or time used by the wireless device. The amount of data and/or time may be monitored at the subscription system node.

Instructions 468 may be executed by the at least one computing device 460 to determine that the amount of data and/or time used by the wireless device is a threshold amount. In some examples, the threshold amount may correspond to an amount of data and/or time that was included as part of the transmission of the first data policy by instructions 464. The threshold amount of data and/or time may correspond to a subscription plan of the wireless device, or may be set by a user of the wireless device if the user wishes to limit the amount of data and/or time used on the network slice.

Instructions 470 may be executed by the at least one computing device 460 to transmit a second data policy to apply at the wireless device. As with the first data policy transmitted by at instructions 464, the second data policy may be transmitted to the SMF node from the PCF node. The second data policy may be transmitted in response to the determination that the amount of data and/or time is a threshold amount made at instructions 468. The second data policy may correspond to a session in which data is accessed over a default slice, as opposed to accessing data over the network slice on the uplift session or being on an uplift session for a particular period of time.

In some examples, the at least one computing device 460 may further execute instructions to transmit a notification that the amount of data and/or time used by the wireless device is a threshold amount, with the notification being transmitted to the wireless device. The notification may be transmitted in response to the determination that the amount of data and/or time is the threshold amount at instructions 468 or in response to the transmission of the second data policy at instructions 470. In some examples, transmitting the notification to the wireless device includes providing user options in response to the amount of data being the threshold amount of data. The user options may include options to uplift usage (i.e., increase the amount of allowed data to be used by the wireless device while on the network slice or the amount of time to be on the network slice), establish a new session, or throttle an existing session (i.e., slow the rate of data usage while on the network slice). The user may then select an option based on considerations including their current usage, needs, subscription plan, etc. In response to user selection of an option, the at least one computing device 460 may execute instructions to update a data policy at the PCF node, thus allowing the PCF node to update the SMF node with the most up-to-date data policy for the wireless device.

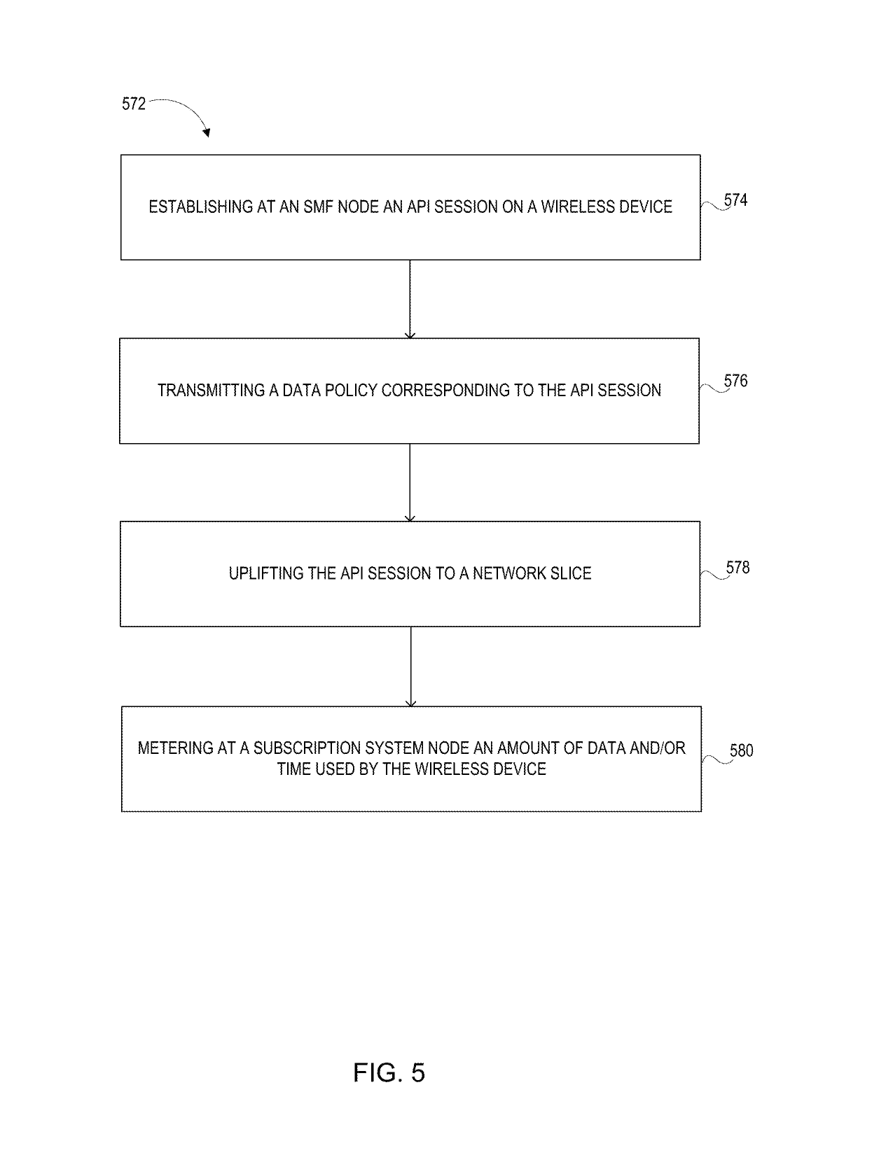

FIG. 5 illustrates another example method 572 for network slice metering in accordance with disclosed embodiments. Method 572 may be performed by any suitable combination of processors and nodes discussed herein, for example a processor contained in a network as a service (NaaS) node.

Method 572 begins at step 574 with establishing an application programming interface (API) session on a wireless device. The API session may be established at a session management function (SMF) node and may be established in response to a request from a wireless device. In some examples, the API session may take the form of a Quality on Demand (QoD) request, in which a user is requesting access to a particular network slice.

Method 572 continues at step 576 with transmitting a data policy corresponding to the API session on the wireless device. The data policy may be transmitted from a policy control function (PCF) node to the SMF node. The data policy may correspond to an amount of data to be used by the wireless device on the network slice.

At step 578, method 572 includes uplifting the API session to the network slice. Uplifting the API network slice may include connecting the wireless device to the network slice. In some examples, the wireless device may be disconnected from a prior session and reconnected to a network to allow the wireless device to connect to the network slice, allowing the API session to operate on the network slice.

Method 572 continues at step 580 with metering an amount of data used by the wireless device on the network slice. The data may be metered at a subscription system node. In some examples, the subscription system node may have received the data policy transmitted at step 576, such that the data metering occurring at the subscription system node is occurring in view of the data policy associated with the API session and the wireless device. In some examples, the metering may further comprise metering an amount of time that the wireless device is on the network slice.

Method 572 may further include determining, at the subscription system node, that the amount of data used by the wireless data has reached a threshold amount of data. The threshold amount of data may correspond to an amount of data transmitted by the PCF node at step 576. In some examples, in response to the determination that the amount of data has reached the threshold amount of data, method 572 may further include transmitting the determination from the subscription system node to the PCF node.

In some examples, responsive to the determination that the amount of data has reached a threshold amount of data, method 572 may include transmitting a notification of the determination to the wireless device. The notification of the determination may include providing a plurality of options for data usage above the threshold amount of data. Example options include options to uplift usage, establish a new session, or throttle an existing session, although examples are not so limited. The user may select from the plurality of options provided.

Method 572 may further include transmitting a second data policy from the PCF node to the SMF node. In some examples, the second data policy may be transmitted in response to the determination that the amount of data used by the wireless device has reached a threshold amount of data. In response to transmitting the second data policy to the SMF node, the wireless device may be moved to a default network slice from the uplifted network slice. In some examples, the second data policy may be informed by an option selected by the user from options provided for data usage above the threshold amount of data.

In some embodiments, methods 346 and 572 may include additional steps or operations. Furthermore, the methods may include steps shown in the other methods. As one of ordinary skill in the art would understand, the methods of 346 and 572 may be integrated in any useful manner and the steps may be performed in any useful sequence. Similarly, the instructions executed as part of system 456 may include instructions corresponding additional steps or operations, and may include instructions corresponding to the steps shown in methods 346 and 572. As one of ordinary skill in the art would understand, the instructions executed in system 456 may be integrated in any useful manner and may be executed in any useful sequence.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
establishing an application programming interface (API) session at a wireless device;
validating, at an identity access management (IAM) node, an availability of a session for the API on a network slice;
adding a service offer code (SOC) associated with the network slice at a network as a service (NaaS) node; and
attaching the wireless device to a core network associated with the network slice at a network provisioning engine (NPE).

2. The method of claim 1, further comprising activating a meter at the NPE.

3. The method of claim 2, wherein activating a meter at the NPE comprises monitoring an amount of data usage on the network slice.

4. The method of claim 2, wherein activating a meter at the NPE comprises monitoring an amount of time of the wireless device on the network slice.

5. The method of claim 2, further comprising:
determining that a meter threshold has been reached; and
moving the wireless device off the network slice in response to the determination.

6. The method of claim 1, further comprising:
determining, at a network access point (NAP), the network slice is established; and
instructing the NaaS node to begin the API session on the network slice.

7. The method of claim 1, wherein adding a SOC associated with the network slice further comprises instructing a subscription system to establish the network slice.

8. The method of claim 1, wherein attaching the wireless device to a core network associated with the network slice at an NPE comprises:
canceling a prior network attachment of the wireless device; and
reattaching the wireless device to the core network to move the device to the network slice.

9. A system, comprising:
a wireless device connected to a network slice; and
a wireless network comprising at least one computing device communicatively connected to the wireless device, wherein the at least one computing device is configured to perform operations, the operations including:
transmitting to a session management function (SMF) node, from a policy control function (PCF) node, a first data policy to apply to data at the wireless device;
metering, at a subscription system node, an amount of data used by the wireless device;
determining, at the subscription system node, that the amount of data used by the wireless device is a threshold amount of data; and
in response to the determination that the amount of data is a threshold amount of data, transmitting to the SMF node, from the PCF node, a second data policy to apply to data at the wireless device.

10. The system of claim 9, further comprising operations including transmitting, to the wireless device, a notification that the amount of data used by the wireless device is a threshold amount of data.

11. The system of claim 10, wherein transmitting a notification to the wireless device further comprises providing user options in response to the amount of data being the threshold amount of data.

12. The system of claim 11, wherein providing user options comprises:
providing options to uplift usage, establish a new session, or throttle an existing session; and
responsive to a user selection of an option, updating a data policy at the PCF node.

13. The system of claim 9, wherein transmitting a first data policy to apply to data at the wireless device further comprises operations including:
transmitting a notification that the wireless device is on the network slice to an enterprise multi-mediation (EMM) node from the subscription system node; and
transmitting a call data record (CDR) including an indication that the wireless device is on the network slice, wherein the CDR is transmitted from the EMM node to the subscription system node.

14. The system of claim 13, wherein transmitting a CDR to a subscription system node from the EMM node comprises transmitting an uplift session CDR to the subscription system node.

15. The system of claim 9, wherein:
the first data policy corresponds to an uplift session corresponding to accessing data over the network slice; and
the second data policy corresponds to a session corresponding to accessing data over a default slice.

16. A method, comprising:
establishing, at a session management function (SMF) node, an application programming interface (API) session on a wireless device;
transmitting, from a policy control function (PCF) node to the SMF node, a data policy corresponding to the API session on the wireless device;
uplifting the API session to a network slice in response to the transmitted data policy; and
metering, at a subscription system node, an amount of data used by the wireless device on the network slice.

17. The method of claim 16, further comprising:
determining, at the subscription system node, that the amount of data used by the wireless device has reached a threshold amount of data; and
transmitting, to the PCF node from the subscription system node, the determination that the amount of data has reached a threshold amount of data.

18. The method of claim 17, further comprising:
responsive to determining that the amount of data used by the wireless device has reached a threshold amount of data, transmitting to the wireless device a notification of the determination; and
providing a plurality of options for data usage above the threshold amount of data.

19. The method of claim 17, further comprising:
transmitting a second data policy to the SMF node from the PCF node; and
moving the wireless device to a default network slice.

20. The method of claim 16, wherein metering, at the subscription system node, an amount of data used by the wireless device on the network slice further comprises metering an amount of time the wireless device is on the network slice.
